(19) United States
(12) Patent Application Publication
(10) Pub. No.: US 2004/0182776 A1
(43) Pub. Date: Sep. 23, 2004

(54) Filtration system, cartridge to be applied in the filtration system and method for filtering out particles from a liquid

(76) Inventor: Marcellus Johannes Hubertus Raedts, Emmen (NL)

Correspondence Address: YOUNG & THOMPSON, 745 SOUTH 23RD STREET 2ND FLOOR, ARLINGTON, VA, 22202

(21) Appl. No.: 10/815,855

(22) Filed: Apr. 2, 2004

Related U.S. Application Data
(63) Continuation of application No. PCT/NL02/00634, filed on Oct. 1, 2002.

(30) Foreign Application Priority Data
Oct. 12, 2001 (NL) 1019167

(51) Int. Cl. B01D 29/33; B01D 29/66

(52) U.S. Cl. 210/411; 210/448; 210/497.01; 210/502.1

(57) ABSTRACT

The invention relates to a filtration system for filtering out particles, like molecules or proteins. The filtration system comprises a filter body (1) having a radial symmetry, which comprises a filter element (14) also having a radial symmetry, through which the liquid to be filtered is pressed from the outside in. A substantial part of the liquid to be filtered is directed tangentially alongside the filter surface, as a result of which the filter surface can be used longer before it will block. The filter element (14) comprises an adsorptive matrix, like a resin, to which the particles to be filtered are adsorbed. The filter element (14) is implemented as a cartridge, thanks to which the filtration system can be cleaned easily and fast, so that it can be used immediately for filtering out other types of particles.

The invention relates to a filtration system for filtering out particles from a liquid, comprising a filter body having an at least substantially radial symmetry, provided with a filter element having an at least substantially radial symmetry through which the liquid to be filtered is pressed in an at least substantially radial direction.

A filtration system of this kind is known from U.S. Pat. No. 6,257,416. The disadvantage of the known filtration system is that the filter element easily blocks. More in particular, the surface of the filter element that contacts the liquid to be filtered easily gets clogged up. In the known filtration system, the liquid is pressed through the filter element from the inside out. A favourable embodiment according to a first aspect of the invention is characterised in that the liquid is pressed from the outside in. As the surface area of the outside of the filter element is larger than the surface area of the inside of the filter element, the filter element will less easily block.

For the known filtration system, the flow of liquid near the surface of the filter is at least substantially radially directed. A very favourable embodiment according to a further aspect of the invention is characterised in that the filtration system is provided with a first outlet through which a first stream of filtered liquid may flow and with a second outlet through which a second stream of an at least substantial tangentially directed, alongside an outside of the filter element flowing liquid may flow. The liquid, flowing tangentially alongside the outside brings about a profound cleaning of the surface, as a result of which it will take more time before the filter blocks.

In this embodiment, the filtration system according to the invention is preferably provided with adjusting means, adjusting the first stream and the second stream, such that the first stream amounts to five to twenty percent of the second stream. For an adjustment for which for example ten percent is filtered and the remainder of the liquid is recirculated, the costs of energy do not significantly raise, while the life expectancy duration of the filter does significantly increase.

A favourable embodiment according to a further aspect of the invention is characterised in that the filter element has a toroidal shape with an at least substantially rectangular cross section, of which the opposite annular shaped sides are impermeable for a liquid, the coaxial arranged tubular sides are made of a filter material and the toroid is filled with a matrix, like a resin. In this case, the filter material is usually selected such as to let pass only particles which are smaller than a predefined value, while the matrix is selected for adsorbing predefined particles in a manner well known in the art.

It is generally known that for adsorbing particles onto a matrix, there exists an optimal rate of flow, which means a rate of flow for which the binding of the particles to the matrix is optimal. In the toroidally shaped filter element, the rate of flow is not constant as the rate of flow of the liquid increases from the outside towards the inside. A favourable embodiment, for which this disadvantage is substantially obviated, is characterised in that an inside diameter of the filter element amounts to forty to sixty percent of an outside diameter of the filter element.

For filter systems to be used in the food industry and especially in the bio-pharmacology, it is of great importance that the filter element is clean. Often, it is not sufficient to clean the filter so that after the cleaning the filter must undergo a time consuming check. A favourable embodiment that obviates these drawbacks is characterised in that the filter element is implemented as a cartridge and consequently can be replaced fast and easily. The cartridge may be of a disposable type or it can be cleaned and checked off-line, in such a way that the filter process itself can take place substantially uninterrupted. If the cartridge is replaced then the filter body will normally be cleaned as well, but this can be done fast and adequate, because of the chosen design that complies with the prevailing standards for sanitary designs. The design of the filter body is moreover determined by the fact that there must be little empty space around the filter element, because this space is in fact dead space which negatively influences the efficiency of the filter process.

An important additional advantage of the application of a cartridge is that a filter body and the accompanying equipment can be used for realising different types of filter processes, in which case one may select a matching cartridge for a specific type of filter process. It is also possible now to carry out a multistage filter process with only one filtration system, by replacing the filter a few times.

An embodiment according to another aspect of the invention is characterised in that the filtration system is provided with a filler body, for filling up a central cavity present in the toroidal shaped filter element. In this case, the filler body is preferably at least partly made of a flexible material and includes a cavity filled with a gas. During the filter process, the pressure in the filtration system may periodically be increased for example by introducing restrictions in the first stream and the second stream, as a result of which the filler body will assume a smaller volume. If subsequently the restriction in the second stream is cancelled, part of the liquid present in the central cavity will pass the toroidal shaped filter element in an opposite direction and releases particles that may have settled to the outer surface, which particles will be washed down next by the second stream.

The invention also relates to a cartridge, suitable to be applied in a filtration system as disclosed. Normally, the cartridge will be filled under pressure with a resin which has been selected for the adsorption of specific valuable molecules or on the contrary, for the adsorption of specific unwanted components. By filling the cartridge under pressure, one prevents the resin from significantly shrinking during use. It becomes possible then to use very big cartridges, with a volume of tens of litres.

The invention also relates to a method for filtering out particles, present in a liquid, in the process of which the liquid is passed in an at least substantially radial direction through a filter body and a filter element with an at least substantially radial symmetry. The inventive method is characterised in that the liquid is pressed from the outside in, in such a way that a first stream of filtered liquid leaves the filter body via a first outlet and a second stream of non-filtered liquid via second outlet, and that the second stream previously passes alongside an outside of the filter element in an at least substantially tangential direction.

A favourable realisation of the inventive method is characterised in that the filter body is filled with a matrix, for example a resin, onto which in a first process step specific particles, present in the liquid, can be adsorbed. In a further favourable realisation in which the particles can be retrieved, the inventive method is characterised in that particles, adsorbed onto the matrix are washed off the matrix in a second process step with the aid of a suitable rinsing liquid.

A further favourable realisation according to another aspect of the invention is characterised in that in the centre of a toroidal shaped filter body a flexible, gas-filled filler body is placed, which is periodically made to shrink during the first process step by restricting the first and the second flow and to expand by no longer restricting the second stream and subsequently the first stream. During the expansion, a small quantity of liquid will pass the filter in an opposite direction and releases particles that may have settled to the outer surface, which particles will be washed down next by the second stream.

The invention will further be explained with a reference to the following figures, in which:

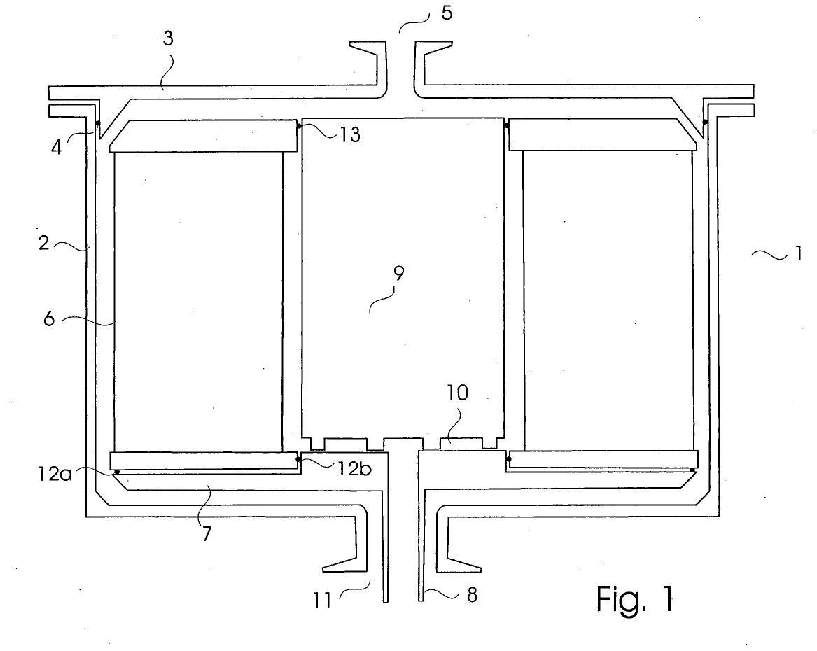

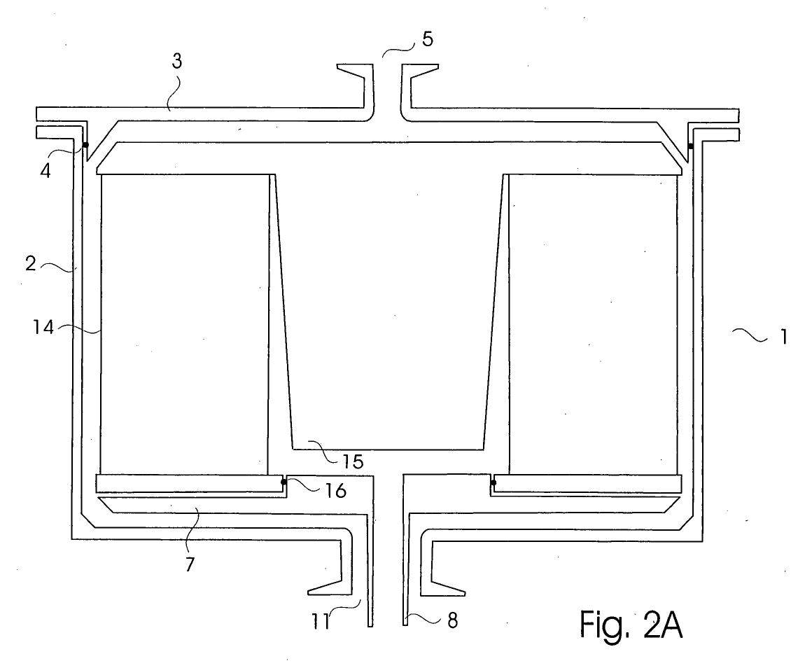

FIG. 1 represents a possible realisation of the inventive filter body;

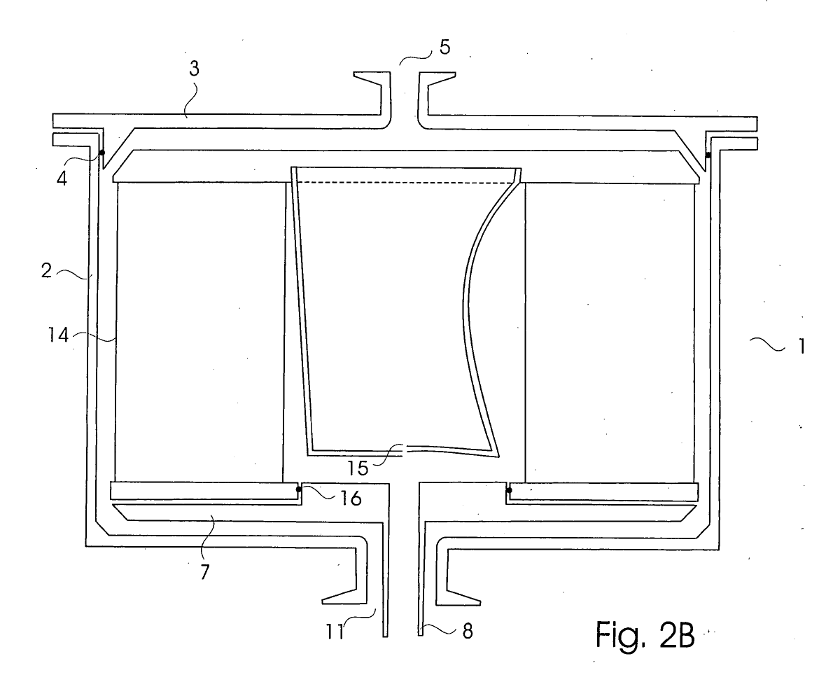

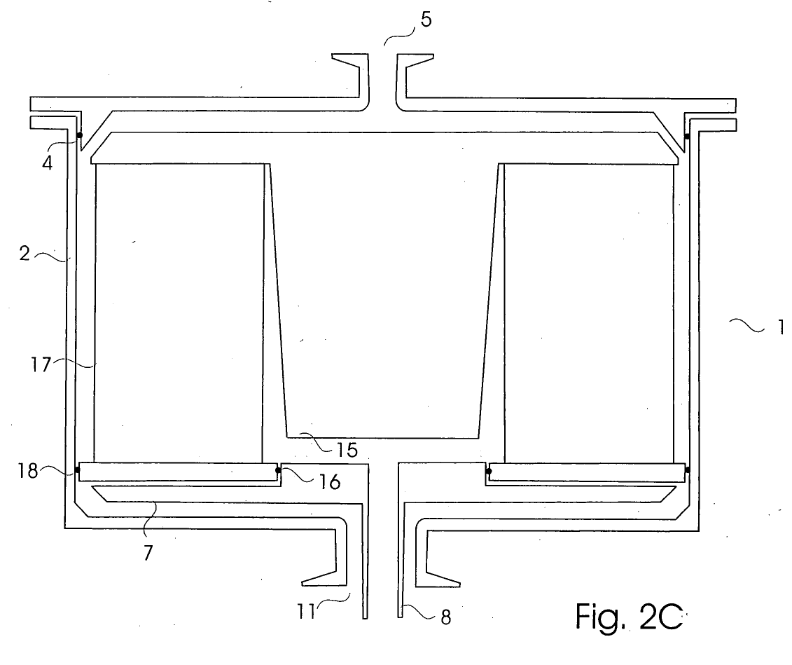

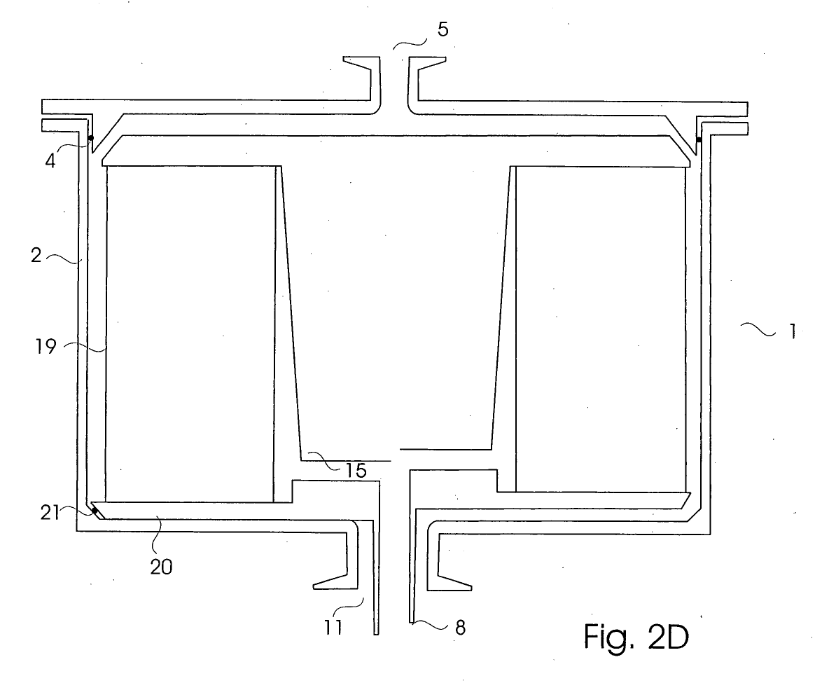

FIG. 2A represents an alternative realisation of the inventive filter body;

FIG. 2B represents another alternative realisation of the inventive filter body;

FIG. 2C represents another alternative realisation of the inventive filter body;

FIG. 2D represents another alternative realisation of the inventive filter body;

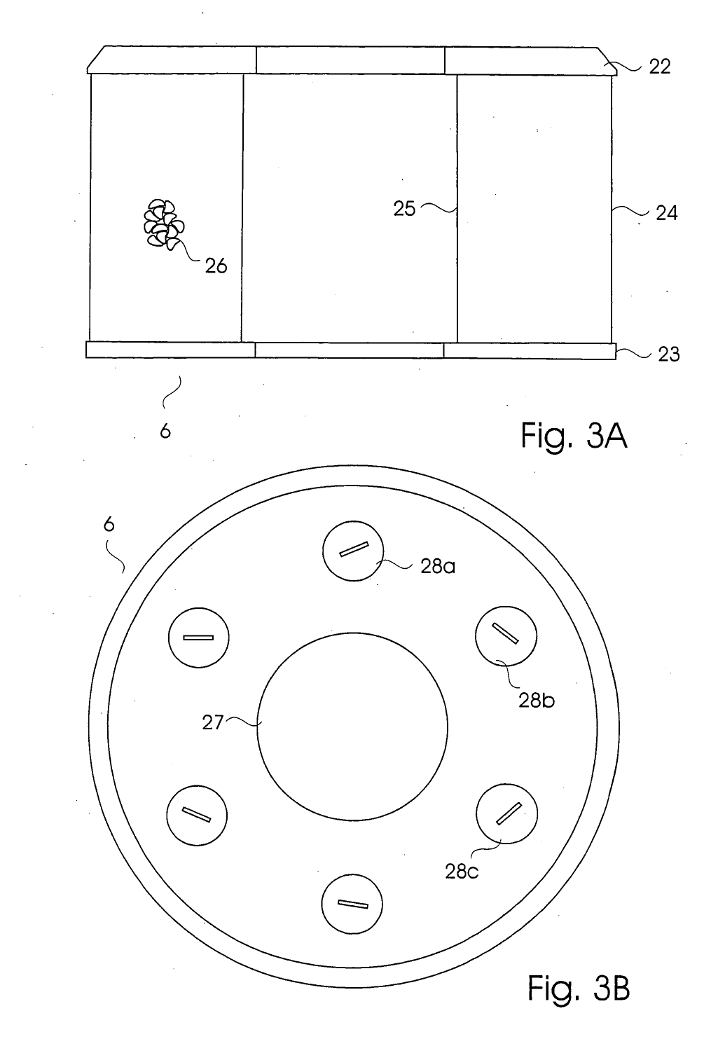

FIG. 3A represents in cross section and more in detail the filter element shown in FIG. 1;

FIG. 3B represents in top view and more in detail the filter element shown in FIG. 1;

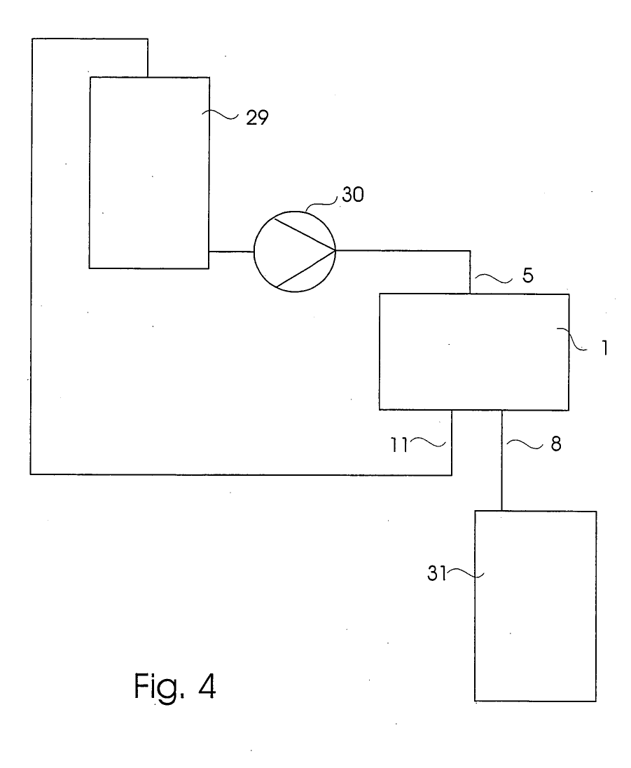

FIG. 4 schematically represents a filter process;

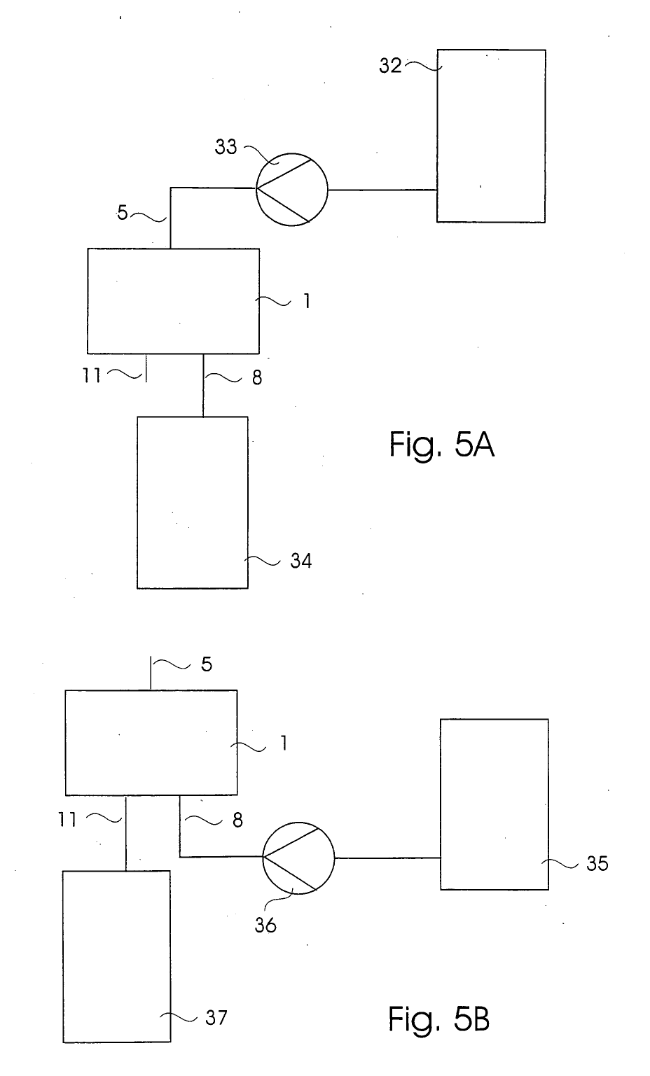

FIG. 5A schematically represents the rinsing out of retrieved particles;

FIG. 5B schematically represents the cleaning of the filter body.

FIG. 1 represents a possible realisation of the inventive filter body 1, comprising a pressure vessel consisting of a kettle 2 and a lid 3, which can be clamped together with the aid of a clamping system, not shown, and a sealing device, for example an O-ring 4 for obtaining a hermetic seal in the closed position. Via an inlet 5, a liquid can be supplied to filter body 1 out of which particles, for example molecules or proteins are to be removed or, on the contrary, gained. In filter body 1, a filter element 6 is placed having a radial symmetry, through which liquid is pressed from the outside in. Filter element 6 is placed on top of a disc 7, provided with an outlet pipe 8, through which filtered liquid can leave filter body 1. Filter element 6 is annular shaped here, with a filler body 9 substantially filling the space in filter element 6, in such a manner that little filtered liquid will remain behind in filter body 1. On the bottom side, filler body 9 is provided with grooves 10, via which the filtered liquid can reach outlet pipe 8. According to the invention, a major part of the liquid to be filtered, supplied via inlet 5, will flow alongside the outside of filter element 6, as a result of which particles, settled on the outside of filter element 6 will be washed off and blocking of the surface is prevented. Liquid that has been directed alongside filter element 6 is drained away via an outlet 11 for further processing or recycling. As a seal between filter element 6 and disc 7, two O-rings 12a,12b are used in this embodiment and as a seal between filter element 6 and filler body 9, an O-ring 13 is used. Preferably, the O-rings are placed in grooves in filter element 6, which makes the cleaning of disc 7 and filler body 9 easier. Filter element 6 and disc 7 are kept in an obvious manner in the shown position, for example with the aid of a number of projections, not shown, which rest against the inside of filter body 1.

FIG. 2A represents an alternative realisation of the inventive filter body 1, comprising a pressure vessel consisting of a kettle 2 and a lid 3, which can be clamped together with the aid of a clamping system, not shown, and a sealing device, for example an O-ring 4 for obtaining a hermetic seal in the closed position. Via an inlet 5, a liquid can be supplied to filter body 1 out of which particles, for example molecules or proteins are to be removed or, on the contrary, gained. In filter body 1, a filter element 6 is placed having a radial symmetry, through which a liquid is pressed from the outside in. Filter element 14 is placed on top of a disc 7, provided with an outlet pipe 8, through which filtered liquid can leave filter body 1. A top side of filter element 14 is completely closed and the space inside filter element 14 is substantially filled by a bulge 15, in such a manner that little filtered liquid will remain behind inside filter body 1. The filtered liquid can reach outlet pipe 8 unhindered now. In this embodiment also a major part of the liquid to be filtered, supplied via inlet 5, will flow alongside the outside of filter element 14, as a result of which particles, settled on the outside of filter element 14 will be washed off and blocking of the surface is prevented. The liquid that has been directed alongside filter element 14 is drained away via an outlet 11 for further processing. As a seal between filter element 6 and disc 7, one O-ring 16 is used in this embodiment, preferably placed in a groove in filter element 14, which makes the cleaning of disc 7 easier.

FIG. 2B represents another alternative realisation of the inventive filter body, in which bulge 15 is made of a flexible material, like rubber, and includes a cavity filled with a gas. The left part of the figure shows bulge 15 in a situation in which the pressure in the gas filled cavity is larger that the pressure in its surroundings. In that situation, the shape of bulge 15 is substantially the same as the shape of the bulge shown in FIG. 2A. The right part of the figure shows bulge 15 in a situation in which the pressure of its surroundings is larger, which results in bulge 15 assuming a smaller volume. The larger pressure may easily be obtained during the filter process by partly closing outlet pipe 8 and outlet 11. If subsequently outlet 11 is opened again, then liquid will be pressed in a radial direction through filter element from the inside out, which causes particles which have settled on the outside of filter element 14 to become detached and to drift away with the tangential flow of liquid. Subsequently, outlet pipe 8 may be opened again and the actual filter process is resumed. It goes without saying that bulge 15 can be made of other materials, for example of stainless steel shaped as a bellow.

FIG. 2C represents another alternative realisation of the inventive filter body, which may be used for filtering a liquid which contains almost no solid particles, in the sense that there is no need to previously filter the liquid on the outside of filter element 17. In this case, it is unnecessary to direct part of the liquid in a tangential direction alongside the outside. For that reason, filter element 17 is given a larger outside diameter and use is made of an O-ring 18 to force the entire liquid flow supplied via inlet 5 through filter element 17 and to make it leave filter body 1 via pipe 8. In this embodiment, filter element 17 is again filled with a resin that may adsorb previously determined particles from the liquid. The outside of the filter element may for example exist of a metal mesh, which prevents the resin from being pressed out of filter element 17.

FIG. 2D represents another alternative realisation of the inventive filter body, in which disc 7 shown in FIG. 2C is left out. Instead, a filter element 19 is provided with an integrated disc 20. The left part of the figure shows by way of illustration a filter element with a relatively large length and an integrated disc 20 provided with an O-ring 21. As a result, no liquid will flow in a tangential direction alongside the outside of filter element 19, like in the embodiment shown in FIG. 2C. The right side of the figure shows by way of illustration a filter element with a relatively short length, without an O-ring 21, as a result of which liquid may flow in a tangential direction alongside the outside of filter element 19 and leave filter body via outlet 11. One of the two embodiments can be placed in order to realise a specific desired filter process.

The O-rings 12a,12b,13,16,18 and 21 may be part of the cartridge or of the remaining parts of the filter body. When they form part of the cartridge, than this will increase the price of the cartridge. However, the advantage is that the cleaning of the remaining parts is easier.

FIG. 3A represents in cross section and more in detail the filter element 6 shown in FIG. 1. Filter element 6 consists of an annular top lid 22 and an annular bottom lid 23, made of for example a synthetic material or stainless steel, between which a tubular external wall 24 and a tubular internal wall 25 are attached. Filter element 6 is filled with particles 26, which form an adsorptive matrix, for example a resin, onto which very specific components of the liquid to be filtered can be bound in a manner well known in the art. External wall 24 in general forms a particle filter, through which the specific component to be bound can pass and by which larger particles that might be present are substantially stopped. External wall 24 may for example be of relatively inexpensive non-woven stainless steel filter mesh, which is available in substantially any desired porosity. This filter mesh may be welded to stainless steel lids 22,23 or for example moulded into synthetic lids 22,23 in an injection-moulding process. In lids 22,23, grooves may be made in which the O-rings can be placed.

FIG. 3B represents in top view and more in detail the filter element 6 shown in FIG. 1, met top lid 22, provided with a central opening 27 in which a filler body 9 is positioned under operational conditions and for example six filler caps 28a, . . . ,28f, which can be screwed into top lid 22 and which make it possible to fill filter element 6 with a suitable resin. More than one filler caps are in general necessary for filling filter element 6 completely to such an extent that the resin filling cannot be compressed any further under operational conditions.

FIG. 4 schematically represents a filter process, in which a liquid to be filtered is pumped out of a vessel 29 to inlet 5 of filter body 1, with the aid of a pump 30.

Filtered liquid, discharged by pipe 8, is collected in a vessel 31 and non-filtered liquid, discharged by outlet 11, is fed back to vessel 29.

FIG. 5A schematically represents the rinsing out of retrieved particles, which have been adsorbed by the resin in the filter element in filter body 1. In order to prevent the particles from becoming contaminated by the particles that have settled onto the outside of the filter element, the same flow direction is maintained. With the aid of a pump 33, a rinsing liquid stored in vessel 32 is for that purpose pumped to inlet 5 of filter body 1. Outlet 11 is closed, which means that the rinsing liquid must pass the filter element and in doing so it will carry off and deposit the particles in a vessel 34 via pipe 8.

FIG. 5B schematically represents the cleaning of the filter body, during which particles that have been adsorbed to the resin in the filter element and particles that have settled to the outside of the filter element are rinsed off at the same time. For that purpose, the direction of the flow-is reversed and the rinsing liquid is pumped from a vessel 35 to pipe 8 with the aid of a pump 36. The particles containing liquid may subsequently leave filter body 1 via outlet 11 and are collected in a vessel 37. During the cleaning, inlet 5 is preferably closed.

1. Filtration system for filtering out particles from a liquid, comprising a filter body having a substantially radial symmetry, provided with a filter element having a substantially radial symmetry through which the liquid to be filtered is pressed in an substantially radial direction, wherein the liquid is pressed from the outside in.

2. Filtration system according to claim 1, wherein the filtration system is provided with a first outlet through which a first stream of filtered liquid, which has passed said filter element, may flow and with a second outlet through which a second stream of a substantial tangentially directed, alongside an outside of the filter element flowing liquid may flow.

3. Filtration system according to claim 2, wherein adjusting means are provided, for adjusting the first stream and the second stream, such that the first stream amounts in the range from 5% to 20% of the second stream.

4. Filtration system according to claim 2, wherein the filter element has a toroidal shape with a substantially rectangular cross section, of which the opposite annular shaped sides are impermeable for a liquid, the coaxial arranged tubular sides are made of a filter material and the toroid is filled with a matrix absorbing particles present in the liquid.

5. Filtration system according to claim 4, wherein said matrix comprises a resin.

6. Filtration system according to claim 4, wherein an inside diameter of the filter element amounts in the range from 40% to 60% of an outside diameter of the filter element.

7. Filtration system according to claim 4, wherein the filter element is implemented as a cartridge.

8. Filtration system according to claim 4, wherein the filter element is provided with a filler body, for filling up a central cavity present in the toroidal shaped filter element.

9. Filtration system according to claim 8, wherein the filler body is at least partly made of a flexible material, and includes a cavity filled with a gas.

10. Filtration system according to claim 8, wherein said filler body is collapsable against an elastic return force at a first liquid pressure within said filter element and is underformed at a second liquid pressure within said filter element, wherein said first liquid pressure is higher than said second liquid pressure.

11. Filtration system for filtering out particles from a liquid, comprising a filter body having a substantially radial symmetry and an inner face and inside said filter body a filter element having a substantially radial symmetry, said filter element having a liquid impervious top face, a liquid impervious bottom face and a liquid permeable and particle impervious radial side face of filter material, which faces of said filter element are spaced from said inner face of said filter body providing a first liquid flow channel running within said filter body externally of said filter element from a liquid inlet at said inner face of said filter body opposite said top face of said filter element to a first liquid outlet for unfiltered liquid at said inner face of said filter body opposite said bottom face of said filter element, from which first liquid flow channel a second liquid flow channel branches off at said radial side face of said filter element, which second liquid flow channel passess said radial side face of said filter element extends through said filter element onto a second liquid outlet for filtered liquid at said inner face of said filter body opposite said bottom face of said filter element, such that liquid to be filtered is supplied into said filter body through said liquid inlet, flows through said first liquid flow channel and than partially branches off into said second liquid flow channel to pass said filter element in a substantial radial, inward direction and leaves said filter body through said second liquid outlet as filtered liquid.

12. Filtration system according to claim 11, wherein said second liquid flow channel passess a matrix within said filter element, which matrix absorbs particles present in the liquid flowing through said second liquid flow channel, wherein said filter element has a central cavity that is filled with an elastically collapsible filler body which can be brought from an undeformed into a collapsed shape, and wherein said filler body provides a flexible wall of said second liquid channel within said filter element, which wall is impervious to liquid flowing within said second liquid channel, wherein said flexible wall of said filler body obtains a deflected position due to collapsing against an elastic return force of said filler body at a first liquid pressure within said second liquid channel within said filter element and is undeflected at a second liquid pressure within said second liquid channel within said filter element, wherein said first liquid pressure is higher than said second liquid pressure, and wherein said second liquid channel is expanded when said flexible wall is in its deflected position.

13. Filtration system according to claim 12, wherein said second liquid channel is filled with a liquid at said first liquid pressure, said filler body is collapsed and said second liquid outlet is closed such that when said first liquid pressure changes to said second liquid pressure, the liquid within said second liquid channel inside said filter element is pressed outward from said filter element through said radial side face of said filter element by the filler body returning to its undeformed shape.
